(19) United States
(12) Patent Application Publication
(10) Pub. No.: US 2005/0227863 A1
(43) Pub. Date: Oct. 13, 2005

(54) Process for aryl-aryl carbon to carbon bond formation by arylation of aryl halide or an aromatic compound

(75) Inventors: Vasant Ramchandra Choudhary, Pune (IN); Rani Jha, Pune (IN)

Correspondence Address: William R. Evans;Ladas & Parry, 26 West 61 Street, New York, NY, 10023, US

(73) Assignee: Council of Scientific and Industrial Research

(21) Appl. No.: 10/814,860

(22) Filed: Mar. 31, 2004

(51) Int. Cl. B01J 27/06; B01J 27/187

(52) U.S. Cl. 502/214; 585/469; 502/208; 502/224; 502/226; 502/227; 502/229

(57) ABSTRACT

A solid catalyst, consisting of partially halogenated metal oxide or mixed metal oxide or zeolite or zeolite-like solid, represented by a general formula:
X(a)/P_{b}MO_{c}(OH)_{d} wherein, X is halogen element selected from F, Cl, Br and I; P is phosphorous element; M is at least one metallic element selected from alkaline earth metals, rare earth metals, group IIIa metals, non-noble transition metals, Sn, Sb, Bi, Si, thorium and uranium; O is oxygen; H is hydrogen; a is the concentration of halogen element X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and non-metallic elements (M and P); and the ratio of d to c in the range from zero to about 1.0, with or without any catalyst support, useful for the Friedel-Crafts reactions and also its method of preparation are disclosed.

### FIELD OF THE INVENTION

The present invention relates to a partially halogenated solid catalyst useful for the Friedel-Crafts reaction and its method of preparation. This invention particularly relates to a solid catalyst, consisting of partially halogenated metal oxide or mixed metal oxide or micro or meso-porous zeolite or zeolite-like solid, useful for the Friedel-Crafts reactions and method of preparation of the catalyst. The catalyst of this invention can be used in the Friedel-Crafts alkylation and acylation reactions and the process of this invention could be used for the preparation of the catalyst of this invention, useful in the Friedel-Crafts reactions.

### BACKGROUND OF THE INVENTION

A number of homogeneous and heterogeneous acidic catalysts, useful for the Friedel-Crafts reactions, are known in the prior art.

Homogeneous Catalysts for Friedel-Crafts Reactions

The alkylation and acylation of aromatic compounds and related Friedel-Crafts type reactions using homogeneous lewis acid catalysts are well known in the prior art [ref. G. A. Olah, in Friedel-Crafts and related reactions: vol. III, Acylation and related reactions, Wiley-Interscience. Publ., New York, 1963].

Use of CuCl₂ as a homogeneous catalyst in the benzylation of benzene or substituted benzenes by benzyl chloride is disclosed in two U.S. patents; U.S. Pat. No. 3,678,122 (1972) and U.S. Pat. No. 3,679,760 (1972). A French patent, Fr. Demande 2,144,578 (1973), disclosed benzylation of p-substituted phenols by benzyl halides in the presence of homogeneous ZnCl₂ catalyst. A USSR patent, U.S.S.R. 394,353 (1973), disclosed a use of SnSO₄ or SnCl₂ as homogeneous catalyst for the benzylation with benzyl chloride of m-dimethoxy benzene. A Japanese patent, Japan Kokai 7399, 154 (1973), disclosed preparation of dibenzyl benzene derivatives by benzylation of benzene or substituted benzenes using AlCl₃, FeCl₃ and 98% H₂SO₄. A use of H₂SO₄ or H₃PO₄ and optionally 4-CH₃C₆H₄SO₃H, ZnCl₂, BF₃, etc. in the preparation of o-benzyltoluenes by the reaction of α o-chloromethyltoluene with a benzene derivative is disclosed in a German patent, Ger. Offen 2,456,747 (1976). A use of phosphoric acid and optionally H₂SO₄ or a Friedel-Crafts type metal halide in the benzylation of benzene with benzylether is disclosed in a U.S. patent, U.S. Pat. No. 4,049,733 (1977).

German patent, Ger. offen 2,451,037 (1976), disclosed the use of HF as a catalyst for the benzoylation of aromatic compounds. French patent, Fr. Demande FR 2,496,097 (1982) disclosed the acylation of benzene by phthaleic anhydride using HF—BF₃ mixture. European Patent, Eur. Pat. Appl. EP 538,704 (1993), disclosed a process for the preparation of p-substituted o-benzylphenols by treating phenols, p-R′C₆H₄OH(R′=halo, alkyl, OH, alkoxy, alkylmercapto, aryl, aryloxy or arylmercapto), with ArCH₂X (Ar=corresponding aryl nucleus, X=halo, arylcarboxy, phenylsulfatoxy, hydroxy, alkoxy etc.) in a continuously fractionating distillation apparatus in the presence of dissolved acid catalyst.

The main disadvantages of the use of homogeneous acid catalyst for the Friedel-Crafts processes are as follows:

1) The separation and recovery of the dissolved acid catalysts from the liquid reaction mixture is difficult.

2) The disposal of the used acid catalysts creates environmental pollution.

3) The homogeneous acid catalysts also pose several other problems such as high toxicity, corrosion, spent acid disposal and use of more than the stoichiometric amount.

Heterogeneous Catalysts for Friedel-Crafts Reactions

A German patent, Ger. Offen 2,547,030 (1977), disclosed the preparation of o-benzyltoluenes by the reaction of o-methylbenzyl halides with substituted benzenes in the presence of Al-silicate. The 2-CH₃C₆H₄CH₂Cl was stirred with toluene and Al-silicate (25% Al₂O₃) at 110° C. to give 81% 2-methylbenzyltoluene. According to a Japanese patent, Jpn. Kokai Tokkyo Koho JP 59,186,937 (1984), o-benzylphenol was prepared by the liquid phase reaction of benzyl alcohol with phenol in the presence of γ-Al₂O₃. For example 7.5 γ-Al₂O₃ was added to a mixture of 32.5 g benzyl alcohol and 47 g phenol at 190° C. under stirring to give a product containing 49.9% o-benzylphenol. A German Patent, Ger. Offen DE 3,700,917 (1988), disclosed the preparation of p-substituted o-benzylphenols by benzylation of p-substituted phenols with benzylalcohol in the presence of Na—Y type zeolite. A mixture of 0.5 mole 4-ClC₆H₄OH, 0.1 mole C₆H₅CH₂OH and 0.6 g of Na—Y type zeolite was heated at 200° C. for 3 hrs to give 25.4% 2-benzyl-4-chlorophenol.

French patent, Fr. Demande FR 2,667,063 (1992), disclosed the preparation of 4-substituted benzophenones by aroylation of substituted benzenes by substituted benzoic acid in the presence of HY and Hβ type zeolites. Accordingly, 4-Cl C₆H₄COOH and PhMe were heated 4 h at 200° C. under 2×10⁵ Pa in the presence of calcined zeolite Hβ to give 84.4% 4-(4-ClC₆H₄CO)C₆H₄ Me. A German patent, Ger. Offen DE 3,836,780 (1990), disclosed the process for the preparation of benzylbenzenes from benzenes and benzyl alcohols in the presence of activated bleaching earth and a diluent at 90-140° C. According to Japanese patent, Jpn Kokai Tokkyo Koho JP 03,170,442 (1991), benzylbiphenyls are manufactured by benzylating, biphenyl and diphenylmethane with ≧1 compound from benzyl halides, benzyl alcohol, and benzyl ether in the presence of a zeolite or silica-alumina catalyst. A European patent, Eur. Pat. Appl. EP 428,081 (1991), disclosed a process of benzylation of alkylbenzenes with benzyl chloride in the presence of H—Y or H-L zeolite catalyst. According to a German patent, Ger. Offen DE 4,038,933 (1992), disclosed a process for benzylation of aromatics using technical carbon catalysts.

Alkylation or acylation of aromatic compound involves electrophilic substitution of H from the aromatic nucleus of the aromatic compound. It is well known in the prior art that the electrophilic substitution is favoured by the presence of electron donating groups, such as OH, alkyl, alkoxy, phenoxy, amine, alkyl amine, SH etc., in the aromatic compound. Whereas the electrophilic substitution is inhibited by the absence of electron donating group and also by the presence of electron withdrawing groups such as halo, nitro, cyano, carboxy, aldehyde, etc., in the aromatic compound. [ref. G. A. Olah, in Friedel-Crafts and related reactions, Wiley-Interscience Publ., New York, 1963].

Although some limitations of the homogeneous acid catalyzed processes are overcome in the prior art heterogeneous catalyzed processes described above, the alkylating or acylating activity of the solid catalysts used in the prior art processes is low, particularly for alkylating, or acylating aromatic compounds not containing electron donating groups, such as benzene or naphthalene. Hence, there is a great practical need for finding more efficient solid catalyst for the alkylation or acylation of aromatic compounds. This invention is, therefore, made with the following objects so that most of the drawbacks or limitations of the prior art homogeneous and heterogeneous catalyzed processes for the Friedel-Crafts type reactions could be overcome.

1. Accordingly, the main object of this invention is to provide a novel catalyst, derived from catalytically inactive or less active metal oxide, mixed metal oxide, zeolites or zeolite-like materials, which has high activity for the Friedel-Crafts reactions, so that the reaction temperature is low and/or time for completing the reaction is short.

2. Another important object of this invention is to provide novel solid catalyst for the Friedel-Crafts reactions, which can be easily separated and reused repeatedly for the catalytic reactions.

3. Another important object of this invention is to provide a much cheaper solid catalyst having high activity and selectivity in the Friedel-Crafts reaction.

### SUMMARY OF THE INVENTION

The present invention provides a solid catalyst, consisting of partially halogenated metal oxide or mixed metal oxide or zeolite or zeolite-like solid, of the general formula:
X(a)/P_{b}MO_{c}(OH)_{d}
wherein, X is halogen element selected from F, Cl, Br and I, P is phosphorous element; M is at least one metallic element selected from alkaline earth metals, rare earth metals, group ma metals, non-noble transition metals, Sn, Sb, Bi, Si, thorium and uranium; O is oxygen; H is hydrogen; a is the concentration of halogen element X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support useful for the Friedel-Crafts reactions.

In another embodiment of the invention, the halogen element is Cl.

In another embodiment of the solid catalyst of this invention, the metallic element (M) is Be, Mg, Ca, Si, B, Al, Ga, In, Tl, Cr, Fe, Cu, Ni, Y, Th, La, Ce, Pr, Bi or a mixture of two or more thereof.

In another embodiment of the solid catalyst of this invention, the concentration of the halogen element in the catalyst (a) is between 0.1 wt % and 30 wt %.

This invention also provides a process for the preparation of a solid catalyst, consisting of partially halogenated metal oxide or mixed metal oxide or zeolite or zeolite-like solid, represented by a general formula:
X(a)/P_{b}MO_{c}(OH)_{d}
wherein, X is halogen element selected from F, Cl, Br and I; P is phosphorous element; M is at least one metallic element selected from alkaline earth metals, rare earth metals, group IIIa metals, non-noble transition metals, Sn, Sb, Bi, Si, thorium and uranium; O is oxygen; H is hydrogen; a is the concentration of halogen element X present in the catalyst in the range from 0.1 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support, useful for the Friedal-Crafts reactions, which comprises;
i) contacting an inorganic solid comprising surface hydroxyl groups, represented by a general formula: P_{b}MOₙ(OH)ₘ
wherein, P is phosphorous, M is at least one metalic element selected from alkaline earth metals, rare earth metals, group IIIa metals, non-noble transition metals, Sn, Sb, Bi, Si, thorium and uranium; O is oxygen; H is hydrogen; b is the mole ratio of P to M in the range from zero to 1.0; n and m are the number of oxygen and OH groups, respectively, requited to satisfy the valence requirement of the metallic and nonmetallic elements (M and P), and the m to n ratio is above about 0.0001, with or without any catalyst support, with an halogenating agent selected from hydrogen fluoride, hydrogen chloride, hydrogen bromide, hydrogen iodide or gaseous halogens in the presence or absence of moisture-free non-aqueous solvent and inert gas, such that the concentration of halogen in the catalyst is in the range from 0.01 wt % to 50 wt %; and
(ii) desorbing physically adsorbed halogen containing compound from the halogenated solid.

In another embodiment of the solid catalyst of this invention, the metallic element (M) in the inorganic solid is Be, Mg, Ca, Si, B, Al, Ga, In, Tl, Cr, Fe, Cu, Ni, Y, Th, La, Ce, Pr, Bi or a mixture of two or more thereof.

In another embodiment of the solid catalyst of this invention, the non-aqueous solvent is liquid hydrocarbon, carbon tetrachloride or dichloroethane.

In another embodiment of the solid catalyst of this invention, the concentration of the halogen in the catalyst (a) is in the range between 0.1 wt % and 30 wt %.

### DETAILED DESCRIPTION OF THE INVENTION

The main finding of this invention, the partially halogenated solid catalyst of this invention shows high activity in the Friedel-Crafts benzylation and acylation reaction not only when an electron donation group, which is aromatic ring activating group, is present in the aromatic ring of the aromatic compound but also when the ring activating group is absent.

Other important finding of this invention is that the solid catalyst of this invention can be separated from the reaction mixture easily, simply by filtration and also could be reused repeatedly for the Friedel-Crafts reactions. Another important finding is that catalytically inactive solids can be activated simply by their halogenation, yielding highly active but inexpensive or very low cost solid catalyst, useful for the Friedel-Crafts reactions.

The present invention provides a solid catalyst, consisting of a partially halogenated metal oxide or mixed metal oxide or zeolite or zeolite-like solid, represented by a general formula X(a)/P_{b}MO_{c}(OH)_{d} wherein, X is halogen element selected from F, Cl, Br and I; P is phosphorous element; M is at least one metallic element selected from alkaline earth metals, rare earth metals, group IIIa metals, non-noble transition metals, Sn, Sb, Bi, Si, thorium and uranium; O is oxygen; H is hydrogen; a is the concentration of halogen element X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support, useful for the Friedal-Craft reactions. The catalyst of this invention may be with or without a porous catalyst support. Examples of commonly used catalyst supports are micro or mesoporous silica, silica-alumina, zirconia, other metal oxides, zeolites, clays, etc.

In the solid catalyst of this invention, the preferred halogen element is Cl; the preferred metallic element (M) is Be, Mg, Ca, Si, B, Al, Ga, In, Tl, Cr, Fe, Cu, Ni, Y, Th, La, Ce, Pr, Bi or a mixture of two or more thereof; the preferred concentration of halogen element in the catalyst (a) is between 0.1 wt % and 30 wt %.

The process of preparing the solid catalyst of the invention consisting of a partially halogenated metal oxide or mixed metal oxide or zeolite or zeolite-like solid, represented by a general formula: X(a)/P_{b}MO_{c}(OH)_{d} wherein, X is halogen element selected from F, Cl, Br and I; P is phosphorous element; M is at least one metallic element selected from alkaline earth metals, rare eat metals, group IIIa metals, non-noble transition metals, Sn, Sb, Bi, Si, thorium and uranium; O is oxygen; H is hydrogen; a is the concentration of halogen element. X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support, useful for the Friedel-Crafts reactions, which comprises;
(i) contacting an inorganic solid comprising surface hydroxyl groups, represented by a general formula: P_{b}MOₙ(OH)ₘ wherein, P is phosphorous, M is at least one metallic element selected from alkaline earth metals, rare earth metals, group IIIa metals, non-noble transition metal, Sn, Sb, Bi, Si, thorium and uranium; O is oxygen; H is hydrogen; b is the mole ratio of P to M in the range from zero to 1.0; n and m are the number of oxygen and OH groups, respectively, required to satisfy the valence requirement of the metallic and non-metallic elements (M and P), and the m to n ratio is above about 0.0001, with or without any catalyst support, with an halogenating agent selected from hydrogen fluoride, hydrogen chloride, hydrogen bromide, hydrogen iodide or gaseous halogens in the presence or absence of moisture-free non-aqueous solvent and inert gas, such that the concentration of halogen in the catalyst is in the range from 0.01 wt % to 50 wt %; and
(ii) desorbing physically adsorbed halogen containing compound from the halogenated solid.

A number of inorganic solids comprising surface hydroxyl groups may be used in the process of this invention. Examples of such inorganic solids are microporous zeolites, silica and silicalites, mesoporous Si-MCM-41, zeolites, alumna and zirconia, micro and mesoporous crystalline aluminophosphates, alkaline earth metal oxides, rare earth metal oxides, transition metal oxides, group (III) metal oxides and other metal oxides and binary and ternary mixed metal oxides, clays and the like. The inorganic solid may be without any porous support or may be deposited on a porous support known in the prior art.

Zeolites are crystalline alluminosilicates containing well defined channels or pores of uniform diameter. A large number of microporous (pore size □ 1.0 nm) zeolites, such as X, Y, mordenite, L, beta, ZSM-5, ZSM-8, ZSM-11, and other synthetic and natural zeolites and mesoporous (pore size=1.5 nm to 50 nm) zeolites, such as M41S type material, e.g. MCM-41, are known in the prior art [ref, Breck in Zeolite Molecular Sieves, Wiley-Interscience Publ., New York, 1974; Beck and Co-workers, J. Am. Chem. Soc. Vol. 114, page 10834, year 1992; Nature (London) vol. 359, page 710, year 1992]. Zeolite-like solids are crystalline micro or mesoporous materials having zeolite-like structures or layer structure and the examples of the zeolite-like solids are silicalite-I, Si-MCM-41, crystalline microporous or mesoporous aluminophosphates such as AlPO₄-5, synthetic and natural clays, etc. a number is of cation exchange natural and synthetic clays having layered silicate structure, for example montmorillonite, kaoline, and the like, are known in the prior art [ref. R. A. Scoonheydt “Clays: From two to three dimensions” in studies in Surface Science and Catalysis, vol. 58, page 201-238, year 1991; and K. Ohtuska, Chem, Mater., vol. 9, page 2039-2051, year 1997].

In the process of this invention, the preferred halogenating agent is anhydrous HCl or Cl₂; the preferred metallic element in the inorganic solid is Be, Mg, Ca, Si, B, Al, Ga, In, Tl, Cr, Fe, Cu, Ni, Y, Th, La, Ce, Pr, Bi or a mixture of two or more thereof; the preferred non aqueous solvent is liquid hydrocarbon, carbon tetrachloride or dichloroethane; and the preferred concentration of the halogen in the catalyst (a) is between 0.1 wt % and 30 wt %.

The product obtained from the process of this invention is a novel partially halogenated solid catalyst, useful for the Friedel-Crafts reactions in the preparation of fine chemicals.

In step-i of the process of this invention, halogenating agent reacts with the inorganic solid particularly with the surface hydroxyl groups of the inorganic solid, leading to incorporation of the halogen in the lattice of the inorganic solid.

In step-ii of the process, the physically absorbed or adsorbed halogen or halogen containing compound from the halogenated inorganic solid can be removed by desorption from the catalyst in a flow of inert gas such as nitrogen, helium or argon.

In the process of invention, when an non-aqueous solvent is used in step-i of the process of this invention, after the desorption of physically adsorbed or absorbed halogenating agent, the resulting halogenated catalyst is filtered under moisture-free atmosphere and may be dried under vacuum to remove the solvent from the catalyst. The dried catalyst may be stored under moisture-free conditions or in a decicator.

By using the catalyst of this invention, a complete conversion of benzyl chloride in the benzylation of benzene to diphenylmethane at 80° C. with catalyst/benzyl chloride wt/wt ratio of 0.1 and benzene/benzyl chloride mole ratio of 13 can be achieved in a reaction period of 2.0 min.

The present invention is described with respect to the following examples illustrating the catalyst and the catalyst preparation process of this invention and also illustrating the use of the catalyst of this invention in the Friedel-Crafts reactions. These examples are provided for illustrative purposes only and are not to be construed as limitation on the solid catalyst and process of this invention.

Definition of Terms Used in the Examples

Conversion of reactant (%)=mole % of the reactant converted to all products. All the ratios of aromatic compounds to said benzylating or benzoylating agent are mole ratios, Catalyst to benzylating or benzoylating agent ratio is weight ratio.

The flow of gases are measured at 0° C. and 1 atm pressure. Gas hourly space velocity (GHSV) is volume of gas, measured at 0° C. and 1 atm pressure, passed over unit mass of catalyst per hour.

In all the examples, Ac represents aromatic compound to be benzylated or benzoylated and Ba and Bo represent benzylating and benzoylating agent, respectively.

### EXAMPLE-1

A partially halogenated catalyst of this invention: Cl (11.1 wt %)/Si-MCM-41 was prepared by contacting 1 g of Si-MCM-41 having surface area of 1100 m² g⁻¹, with anhydrous HCl-N₂ gas mixture (50% HCl) at a flow rate of 100 cm³ min⁻¹ in the presence of moisture-free 15 ml benzene in a stirred glass reactor of capacity 50 ml at 27° C. for 1 h. After the HCl gas treatment, the halogenated catalyst in the reactor was flushed with a flow of moisture-free nitrogen to remove the HCl present in the reactor and also to desorb the physically adsorbed or absorbed HCl present in the halogenated catalyst. The flushing was continued until no HCl gas was detected in the reactor effluent nitrogen gas. The catalyst was then filtered under moisture-free gas atmosphere and dried under vacuum. The amount of halogen present in the catalyst was determined by dissolving the catalyst in halogen-free nitric acid solution and then determining the halogen by the potentiometric titration with 0.05 M silver nitrate solution. The concentration of chlorine present in the halogenated catalyst was found to be 11.1 wt %. The Si-MCM-41 was prepared by the procedure given by Choudhary et al., (ref. Proceedings of Indian Academy of Sciences, (Chemical Sciences) volume 109, page 229 and year 1997).

### EXAMPLE-2

A partially halogenated catalyst of this invention; Cl (4.5 wt %)/Si-MCM-41 was prepared by contacting 2 g Si-MCM-41 with a chlorine gas at a flow rate of 20 ml.min⁻¹ in a tubular glass reactor (internal diameter=15 mm) at 40° C. for a period of 1 h. After the chlorine treatment, the resulting partially halogenated solid catalyst was flushed with moisture-free nitrogen at a flow rate of 30 cm³ min⁻¹ for a period of 1 h to remove the chlorine adsorbed physically on the catalyst. The concentration of chlorine in the solid catalyst was 4.5 wt %.

### EXAMPLE-3

A partially halogenated catalyst of this invention: Cl (3.4 wt %)/Montmorillonite-K10 was prepared by the procedure same as that described in EXAMPLE-1 except that montmorillonite-K10, obtained from Aldrich Company USA, was used instead of the Si-MCM-41. Concentration of chlorine in the partially halogenated solid catalyst was 3.4 wt %.

### EXAMPLE-4

Partially halogenated solid catalyst of this invention: Cl (1.1 wt %)/Montmorillonite-K10 was prepared by the procedure described in EXAMPLE-2 except that montmorillonite-K10, obtained from Aldrich Company USA, was used instead of the Si-MCM-41. Concentration of chlorine in the partially halogenated solid catalyst was 1.1 wt %.

### EXAMPLE-5

Partially halogenated catalyst of this invention: Cl (4,2 wt %)/H-β was prepared by the procedure described in EXAMPLE-1 except that H-β zeolite was used instead of the Si-MCM-41. Concentration of chlorine in the partially halogenated solid catalyst was 4.2 wt %.

### EXAMPLE-6

Partially halogenated catalyst of this invention: Cl (2.1 wt %)/AlPO₄-5 was prepared by the procedure described in EXAMPLE-1 except that AlPO₄-5 was used instead of the Si-MCM-41. The concentration of chlorine in the partially halogenated solid catalyst was 2.1 wt % AlPO₄-5 was prepared by the same procedure given by Choudhary et al. (Journal of Catalysis, volume 103, page 115 and year 1987).

### EXAMPLE-7

A partially halogenated catalyst of this invention; Cl (0.5 wt %)/Silicalite-I (high silica ZSM-5) zeolite was prepared by the procedure same as that described in EXAMPLE-1 except that Silicalite-I (high silica ZSM-5) was used instead of the Si-MCM-41. The concentration of chlorine in the partially halogenated solid catalyst was 0.5 wt %. Silicalite-I was prepared by the procedure given by Akolekar and Choudhary (ref. Materials Chemistry and Physics, volume 20, page 299 and year 1988).

### EXAMPLE-8

A partially halogenated catalyst of this invention Cl (8.5 wt %)/LaCaNiO₃ was prepared by the procedure same as that described in EXAMPLE-1 except that LaCaNiO₃ was used instead of the Si-MCM-41. The concentration of chlorine in the partially halogenated solid catalyst was 8.5 wt %. LaCaNiO₃ was prepared by the procedure given by Choudhary et al. (ref. Journal of Catalysis, volume 163, page 312 and year 1996).

### EXAMPLE-9

Partially halogenated catalyst of this invention: Cl (6.5 wt %)/Cr₂O₃/Al₂O₃ was prepared by the procedure described in EXAMPLE-1 except that Cr₂O₃/Al₂O₃ was used instead of the Si-MCM-41. The concentration of chlorine in the partially halogenated solid catalyst was 6.5 wt %. The Cr₂O₃/Al₂O₃ was prepared by impregnating 1.9 mmol of Cr-nitrate per gram of alumina, followed by drying and calcination at 500° C. for 1 h.

### EXAMPLE-10

Partially halogenated catalyst of this invention: Cl (0.8 wt %)/BeO was prepared by the procedure described in EXAMPLE-1 except that BeO was used instead of the Si-MCM-41. The Beryllium Oxide was prepared from calcination of beryllium nitrate at 500° C. The concentration of chlorine in the partially halogenated solid catalyst was 0.8 wt %.

### EXAMPLE-11

A partially halogenated catalyst of this invention: Cl (3.1 wt %)/CaO was prepared by the procedure same as that described in EXAMPLE-1 except that CaO, obtained from BDH (LR), was used instead of the Si-MCM-41. The concentration of chlorine in the partially halogenated solid catalyst was 3.1 wt %.

Partially halogenated catalyst of this invention: Cl (1.5 wt %)/B₂O₃ was prepared by the procedure described in EXAMPLE-1 except that B₂O₃, obtained from Qualigens Chemicals, Mumbai, was used instead of the Si-MCM-41. The concentration of chlorine in the partially halogenated solid catalyst was 1.5 wt %.

### EXAMPLE-13

A partially halogenated catalyst of this invention: Cl (6.1 wt %)/Al₂O₃ was prepared by the procedure described in EXAMPLE-1 except that Al₂O₃ was used instead of the Si-MCM-41. Concentration of chlorine in the partially halogenated solid catalyst was 6.1 wt %.

### EXAMPLE-14

A partially halogenated catalyst of this invention: Cl (1.6 wt %)/Fe₂O₃ was prepared by the procedure same as that described in EXAMPLE-1 except that Fe₂O₃ was used instead of the Si-MCM-41. The Fe₂O₃ was prepared from calcination of Fe-nitrate at 500° C. for 4 h. The concentration of chlorine in the partially halogenated solid catalyst was 1.6 wt %.

### EXAMPLE-15

A partially halogenated catalyst of this invention: Cl (5.1 wt %)/Cr₂O₃ was prepared by the procedure same as that described in EXAMPLE-1 except that Cr₂O₃ was used instead of the Si-MCM-41. The Cr₂O₃ was prepared from calcination of Cr-nitrate at 500° C. for 4 h. The concentration of chlorine in the partially halogenated solid catalyst was 5.1 wt %.

### EXAMPLE-16

A partially halogenated catalyst of this invention: Cl (1.7 wt %)/SiO₂ was prepared by the procedure same as that described in EXAMPLE-1 except that SiO₂, obtained from SD Fine Chemicals, India, was used instead of the Si-MCM-1. The concentration of chlorine in the partially halogenated solid catalyst was 1.7 wt %.

### EXAMPLE-17

A partially halogenated catalyst of this invention: Cl (2.3 wt %)/Ce₂O₃ was prepared by the procedure same as that described in EXAMPLE-1 except that Ce₂O₃ was used instead of the Si-MCM-41. The Ce₂O₃ was prepared from calcination of Ce-nitrate at 500° C. The concentration of chlorine in the partially halogenated solid catalyst was 2.3 wt %.

### EXAMPLE-18

A partially halogenated catalyst of this invention: Cl (1.1 wt %)/Y₂O₃ was prepared by the procedure same as that described in EXAMPLE-1 except that Y₂O₃, obtained from Aldrich Company USA, was used instead of the Si-MCM-41. The concentration of chlorine in the partially halogenated solid catalyst was 1,1 wt %.

### EXAMPLE-19

A partially halogenated catalyst of this invention: Cl (0.8 wt %)/Pr₆O₁₁ was prepared by the procedure same as that described in EXAMPLE-1 except that Y₂O₃, obtained from Aldrich Company USA, was used instead of the Si-MCM-41. The concentration of chlorine in the partially halogenated solid catalyst was 0.8 wt %.

### EXAMPLE-20

A partially halogenated catalyst of this invention: Cl (2.1 wt %)/ThO₂ was prepared by the procedure same as that described in EXAMPLE-1 except that thorium oxide, obtained from Aldrich Company USA, used instead of the Si-MCM-1. The ThO₂ was prepared by calcination of Th-nitrate at 500° C. The concentration of chlorine in the partially halogenated solid catalyst was 2.1 wt %.

### EXAMPLE-21

A partially halogenated catalyst of this invention: Cl (4.4 wt %)/La₂O₃ was prepared by the procedure same as that described in EXAMPLE-1 except that La₂O₃, obtained from Aldrich Company USA, was used instead of the Si-MCM-1. The concentration of chlorine in the partially halogenated solid catalyst was 4.4 wt %.

### EXAMPLE-22

A partially halogenated catalyst of this invention: Cl (2.9 wt %)/Bohemite was prepared by the procedure same as that described in EXAMPLE-1 except that Bohemite was used instead of Si-MCM-41. The concentration of chlorine in the partially halogenated solid catalyst was 2.9 wt %.

### EXAMPLES-23-58

These examples illustrate the use of the partially halogenated solid catalyst prepared in EXAMPLES 1-22 for the Friedel-Crafts reactions such as benzylation and benzoylation by benzyl chloride and benzoyl chloride, respectively, of aromatic compounds.

The catalytic benzylation and benzoylation reaction over the partially halogenated solid catalyst was carried out by
i) contacting the pretreated catalyst with 15 cm³ liquid reaction mixture containing aromatic compound and benzyl chloride or benzoyl chloride and optionally a solvent, in a stirred reactor (capacity: 50 cm³) fitted with a reflux condenser, mercury thermometer dipped in the reaction mixture, under vigorous stirring, while bubbling moisture-free N₂ gas through the reaction mixture at the reaction conditions given in TABLES 1-9 and following the course of the reaction by measuring quantitatively the HCl evolved during the reaction by absorbing it in aqueous NaOH solution by a simple acid-base titration using phenolphthalein indicator and
ii) Cooling the reaction mike to room temperature (25° C.) and analysing the products and unconverted reactants present in the reaction mixture, after separating the solid catalyst from it by filtration, using chromatographic technique. The separated catalyst was washed with moisture-free solvent, benzene or toluene and reused in the Friedel-Crafts reactions.

The results are included in Table 1-9. These results indicate that the catalysts of this invention show very high activity in the Friedel-Crafts benzylation and benzoylation reactions. The results in Tables 2 and 3 also show that the catalysts of this invention can be reused repeatedly in the Friedel-Crafts reactions.

TABLE 1
Reaction conditions and results of the benzylation of aromatic compounds over
different partially halogenated solid catalysts prepared in EXAMPLE-1.

| | Example Nos. | | | |
|---|---|---|---|---|
| | Example 23 | Example 24 | Example 25 | Example 26 |
| Catalyst used | Catalyst | Catalyst prepared | Catalyst prepared in | Catalyst prepared in |
| | prepared in | in EXAMPLE-1 | EXAMPLE-1 | Example-1 |
| | Example-1 | | | |
| Reactants: | | | | |
| Aromatic | C₆H₆ | C₆H₅CH₃ | C₆H₄(CH₃)₂ | (CH₃)₂CHC₆H₅ |
| Compound (Ac) | (benzene) | (Toluene) | (p-Xylene) | (Cumene) |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| Weight ratio | | | | |
| Temperature(° C.) | 80° C. | 110° C. | 140° C. | 145° C. |
| Pressure (atm) | 1.0 | 1.0 | 1.0 | 1.0 |
| N₂ flow | 30.0 | 30.0. | 30.0 | 30.0 |
| (cm³ min⁻¹) | | | | |
| Reaction time | 0.1 | 0.11 | 0.08 | 0.1 |
| (h) | | | | |
| Conversion of | 97.0 | 98.0 | 100 | 95.0 |
| Benzylating | | | | |
| Agent (%) | | | | |
| Main product | C₆H₅CH₂C₆H₅ | CH₃C₆H₅CH₂C₆H₅ | C₆H₅(CH₃)₂CH₂C₆H₅ | C₆H₅CH |
| of | (diphenyl-methane) | (benzyl-toluene) | (benzyl-p-xylene) | (CH₃)₂CH₂C₆H₅ |
| Reaction | | | | (benzyl-cumene) |
| By-product of | HCl | HCl | HCl | HCl |
| Reaction | | | | |

TABLE 2
Reaction conditions and results of the benzoylation of aromatic compounds over
different partially halogenated solid catalysts prepared in EXAMPLE-1.

| | Example Nos. | | | |
|---|---|---|---|---|
| | EXAMPLE-27 | EXAMPLE-28 | EXAMPLE-29 | EXAMPLE-30 |
| Catalyst used | Catalyst prepared in | Catalyst | Catalyst | Catalyst prepared in |
| | EXAMPLE-1 | prepared in | prepared in | EXAMPLE-1 after it |
| | | EXAMPLE-1 | EXAMPLE-1 | use in Example-29 |
| | | after its use in | after its use in | |
| | | Example-27 | Example-28 | |
| Reactants: | | | | |
| Aromatic | C₆H₆ | C₆H₅CH₃ | C₆H₄(CH₃)₂ | C₁₀H₈ |
| Compound (Ac) | (benzene) | (Toluene) | (p-Xylene) | (Naphthalene) |
| Benzylating | C₆H₅COCl | C₆H₅COCl | C₆H₅COCl | C₆H₅COCl |
| agent (Bo) | | | | |
| Reaction | | | | |
| Conditions: | | | | |
| Solvent | Nil | Nil | Nil | Ethylene dichloride |
| Ac/Bo mole | 13.0 | 13.0 | 13.0 | 1.1 |
| ratio | | | | |
| Solvent/Bo mole | 0.0 | 0.0 | 0.0 | 12.0 |
| ratio | | | | |
| Catalyst/Bo | 0.4 | 0.4 | 0.4 | 0.4 |
| Weight ratio | | | | |
| Temperature(° C.) | 80° C. | 110° C. | 140° C. | 80° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.13 | 0.12 | 0.15 | 0.16 |
| (h) | | | | |
| Conversion of | 96.0 | 100 | 98.0 | 90.0 |
| Benzylating | | | | |
| agent (%) | | | | |
| Main product | C₆H₅COC₆H₅ | CH₃C₆H₅COC₆H₅ | C₆H₅CO(CH₃)₂C₆H₅ | C₆H₅COC₁₀H₇ |
| of | (benzophenone) | (benzoyl- | (benzoyl-p- | (benzoyl-naphthalene) |
| Reaction | | toluene) | xylene) | |
| By-product of | HCl | HCl | HCl | HCl |
| Reaction | | | | |

TABLE 3
Reaction conditions and results of the benzoylation of aromatic compounds over
different partially halogenated solid catalysts prepared in EXAMPLE-3.

| | Example Nos. | | | |
|---|---|---|---|---|
| | Example 31 | EXAMPLE-32 | EXAMPLE-33 | EXAMPLE-34 |
| Catalyst used | Catalyst | Catalyst prepared | Catalyst prepared in | Catalyst prepared |
| | prepared in | in EXAMPLE-3 | EXAMPLE-3 after | in EXAMPLE-3 |
| | EXAMPLE-3 | after its use in | its use in Example- | after its use in |
| | | Example-31 | 32 | Example-33 |
| Reactants: | | | | |
| Aromatic | C₆H₆ | C₆H₅CH₃ | C₆H₄(CH₃)₂ | (CH₃)₂CHC₆H₅ |
| Compound (Ac) | (benzene) | (Toluene) | (p-Xylene) | (Cumene) |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| Weight ratio | | | | |
| Temperature(° C.) | 80° C. | 110° C. | 140° C. | 145° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.1 | 0.07 | 0.1 | 0.4 |
| (h) | | | | |
| Conversion of | 98.0 | 98.0 | 97.0 | 97.0 |
| Benzylating | | | | |
| agent (%) | | | | |
| Main product | C₆H₅CH₂C₆H₅ | CH₃C₆H₅CH₂C₆H₅ | C₆H₅(CH₃)₂CH₂C₆H₅ | C₆H₅CH(CH₃)₂CH₂C₆H₅ |
| of | (diphenyl- | (benzyl-toluene) | (benzyl-p-xylene) | (benzyl-cumene) |
| Reaction | methane) | | | |
| By-product of | HCl | HCl | HCl | HCl |
| Reaction | | | | |

TABLE 4
Reaction conditions and results of the benzoylation of aromatic compounds over
different partially halogenated solid catalysts prepared in EXAMPLE-3.

| | Example Nos. | | | |
|---|---|---|---|---|
| | EXAMPLE-35 | EXAMPLE-36 | EXAMPLE-37 | EXAMPLE-38 |
| Catalyst used | Catalyst | Catalyst prepared | Catalyst | Catalyst prepared in |
| | prepared in | in EXAMPLE-3 | prepared in | EXAMPLE-3 |
| | EXAMPLE-3 | | EXAMPLE-3 | |
| Reactants: | | | | |
| Aromatic | C₆H₆ | C₆H₅CH₃ | C₆H₄(CH₃)₂ | C₁₀H₈ |
| Compound (Ac) | (benzene) | (Toluene) | (p-Xylene) | (Naphthalene) |
| Benzylating | C₆H₅COCl | C₆H₅COCl | C₆H₅COCl | C₆H₅COCl |
| Agent (Bo) | | | | |
| Reaction | | | | |
| Conditions: | | | | |
| Solvent | Nil | Nil | Nil | Ethylene Dichloride |
| Ac/Bo mole | 13.0 | 13.0 | 13.0 | 1.1 |
| ratio | | | | |
| Solvent/Bo mole | 0.0 | 0.0 | 0.0 | 12.0 |
| ratio | | | | |
| Catalyst/Bo | 0.4 | 0.4 | 0.4 | 0.4 |
| weight ratio | | | | |
| Temperature(° C.) | 80° C. | 110° C. | 140° C. | 80° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.13 | 0.12 | 0.61 | 0.1 |
| (h) | | | | |
| Conversion of | 92.0 | 93.0 | 96.0 | 94.0 |
| benzylating | | | | |
| agent (%) | | | | |
| Main product | C₆H₅COC₆H₅ | CH₃C₆H₅COC₆H₅ | C₆H₅CO(CH₃)₂C₆H₅ | C₆H₅COC₁₀H₇ |
| of | (benzophenone) | (benzoyl-toluene) | (benzoyl-p | (benzoyl-naphthalene) |
| Reaction | | | xylene) | |
| By-product of | HCl | HCl | HCl | HCl |
| Reaction | | | | |

TABLE 5
Reaction conditions and results of the benzylation of Toluene over different
partially halogenated solid catalysts prepared in EXAMPLE 2-6.

| | Example Nos. | | | |
|---|---|---|---|---|
| | EXAMPLE-39 | EXAMPLE-40 | EXAMPLE-41 | EXAMPLE-42 |
| Catalyst used | Catalyst prepared | Catalyst prepared | Catalyst prepared | Catalyst prepared |
| | in EXAMPLE-2 | in EXAMPLE-4 | in EXAMPLE-5 | in EXAMPLE-6 |
| Reactants: | | | | |
| Aromatic | C₆H₅CH₃ | C₆H₅CH₃ | C₆H₅CH₃ | C₆H₅CH₃ |
| Compound (Ac) | (Toluene) | (Toluene) | (Toluene) | (Toluene) |
| Benzylating | C₆H₅CH₂Cl | C₆H₅CH₂Cl | C₆H₅CH₂Cl | C₆H₅CH₂Cl |
| Agent (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature(° C.) | 110° C. | 110° C. | 110° C. | 110° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.1 | 0.1 | 0.08 | 0.06 |
| (h) | | | | |
| Conversion of | 95.0 | 96.0 | 98.0 | 97.0 |
| benzylating | | | | |
| agent (%) | | | | |
| Main product | CH₃C₆H₅CH₂C₆H₅ | CH₃C₆H₅CH₂C₆H₅ | CH₃C₆H₅CH₂C₆H₅ | CH₃C₆H₅CH₂C₆H₅ |
| of | (benzyl-toluene) | (benzyl-toluene) | (benzyl-toluene) | (benzyl-toluene) |
| Reaction | | | | |
| By-product of | HCl | HCl | HCl | HCl |
| Reaction | | | | |

TABLE 6
Reaction conditions and results of the benzylation of Toluene over different
partially halogenated solid catalysts prepared in EXAMPLE 7-10.

| | Example Nos. | | | |
|---|---|---|---|---|
| | EXAMPLE-43 | EXAMPLE-44 | EXAMPLE-45 | EXAMPLE-46 |
| Catalyst used | Catalyst prepared | Catalyst prepared | Catalyst prepared | Catalyst prepared |
| | in EXAMPLE-7 | in EXAMPLE-8 | in EXAMPLE-9 | in EXAMPLE-10 |
| Reactants: | | | | |
| Aromatic | C₆H₅CH₃ | C₆H₅CH₃ | C₆H₅CH₃ | C₆H₅CH₃ |
| Compound (Ac) | (Toluene) | Toluene | Toluene | Toluene |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature(° C.) | 110° C. | 110° C. | 110° C. | 110° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.93 | 0.2 | 0.30 | 0.1 |
| (h) | | | | |
| Conversion of | 92.0 | 97.0 | 98.0 | 96.0 |
| benzylating | | | | |
| agent (%) | | | | |
| Main product | CH₃C₆H₅CH₂C₆H₅ | CH₃C₆H₅CH₂C₆H₅ | CH₃C₆H₅CH₂C₆H₅ | CH₃C₆H₅CH₂C₆H₅ |
| of | (benzyl-toluene) | (benzyl-toluene) | (benzyl-toluene) | (benzyl-toluene) |
| Reaction | | | | |
| By-product of | HCl | HCl | HCl | HCl |
| Reaction | | | | |

TABLE 7
Reaction conditions and results of the benzylation of Toluene over different
partially halogenated solid catalysts prepared in EXAMPLE 11-14.

| | Example Nos. | | | |
|---|---|---|---|---|
| | EXAMPLE-47 | EXAMPLE-48 | EXAMPLE-49 | EXAMPLE-50 |
| Catalyst used | Catalyst prepared | Catalyst prepared | Catalyst prepared | Catalyst prepared |
| | in EXAMPLE-11 | in EXAMPLE-12 | in EXAMPLE-13 | in EXAMPLE-14 |
| Reactants: | | | | |
| Aromatic | C₆H₅CH₃ | C₆H₅CH₃ | C₆H₅CH₃ | C₆H₅CH₃ |
| Compound (Ac) | (Toluene) | (Toluene) | (Toluene) | (Toluene) |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature(° C.) | 110° C. | 110° C. | 110° C. | 110° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.52 | 0.06 | 1.34 | 0.06 |
| (h) | | | | |
| Conversion of | 100 | 97.0 | 100 | 99.0 |
| benzylating | | | | |
| agent (%) | | | | |
| Main product | CH₃C₆H₅CH₂C₆H₅ | CH₃C₆H₅CH₂C₆H₅ | CH₃C₆H₅CH₂C₆H₅ | CH₃C₆H₅CH₂C₆H₅ |
| of | (benzyl-toluene) | (benzyl-toluene) | (benzyl-toluene) | (benzyl-toluene) |
| Reaction | | | | |
| By-product of | HCl | HCl | HCl | HCl |
| Reaction | | | | |

TABLE 8
Reaction conditions and results of the benzylation of Toluene over different
partially halogenated solid catalysts prepared in EXAMPLE 15-18.

| | Example Nos. | | | |
|---|---|---|---|---|
| | EXAMPLE-51 | EXAMPLE-52 | EXAMPLE-53 | EXAMPLE-54 |
| Catalyst used | Catalyst prepared | Catalyst prepared | Catalyst prepared | Catalyst prepared |
| | in EXAMPLE-15 | in EXAMPLE-16 | in EXAMPLE-17 | in EXAMPLE-18 |
| Reactants: | | | | |
| Aromatic | C₆H₅CH₃ | C₆H₅CH₃ | C₆H₅CH₃ | C₆H₅CH₃ |
| Compound (Ac) | (Toluene) | (Toluene) | (Toluene) | (Toluene) |
| Benzylatingagent | C₆H₅CH₂Cl | C₆H₅CH₂Cl | C₆H₅CH₂Cl | C₆H₅CH₂Cl |
| (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature(° C.) | 110° C. | 110° C. | 110° C. | 110° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time (h) | 0.06 | 0.1 | 0.10 | 0.14 |
| Conversion of | 100 | 98.0 | 97.0 | 98.0 |
| benzylating | | | | |
| agent (%) | | | | |
| Main product of | CH₃C₆H₅CH₂C₆H₅ | CH₃C₆H₅CH₂C₆H₅ | CH₃C₆H₅CH₂C₆H₅ | CH₃C₆H₅CH₂C₆H₅ |
| Reaction | (benzyl-toluene) | (benzyl-toluene) | (benzyl-toluene) | (benzyl-toluene) |
| By-product of | HCl | HCl | HCl | HCl |
| Reaction | | | | |

TABLE 9
Reaction conditions and results of the benzylation of Toluene over different
partially halogenated solid catalysts prepared in EXAMPLE 19-22.

| | Example Nos. | | | |
|---|---|---|---|---|
| | EXAMPLE-55 | EXAMPLE-56 | EXAMPLE-57 | EXAMPLE-58 |
| Catalyst used | Catalyst prepared | Catalyst prepared | Catalyst prepared | Catalyst prepared |
| | in EXAMPLE-19 | in EXAMPLE-20 | in EXAMPLE-21 | in EXAMPLE-22 |
| Reactants: | | | | |
| Aromatic | C₆H₅CH₃ | C₆H₅CH₃ | C₆H₅CH₃ | C₆H₅CH₃ |
| Compound (Ac) | (Toluene) | (Toluene) | (Toluene) | (Toluene) |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature(° C.) | 110° C. | 110° C. | 110° C. | 110° C. |
| Pressure (atm) | 1.0 | 1.0 | 1.0 | 1.0 |
| N₂ flow | 30.0 | 30.0 | 30.0 | 30.0 |
| (cm³ min⁻¹) | | | | |
| Reaction time | 0.1 | 0.5 | 0.2 | 1.4 |
| (h) | | | | |
| Conversion of | 96.0 | 100 | 97.0 | 87.0 |
| benzylating | | | | |
| agent (%) | | | | |
| Main product | CH₃C₆H₅CH₂C₆H₅ | CH₃C₆H₅CH₂C₆H₅ | CH₃C₆H₅CH₂C₆H₅ | C₆H₅CH₂CH₃C₆H₅ |
| of | (benzyl-toluene) | (benzyl-toluene) | (benzyl-toluene) | (benzyl-toluene) |
| Reaction | | | | |
| By-product of | HCl | HCl | HCl | HCl |
| Reaction | | | | |

### EXAMPLES 59-66

These examples illustrates the catalytic activity in the toluene benzylation of Si-MCM-41, silicalite, Mont.-K10, Al₂O₃, B₂O, CaO, La₂O₃ and Y₂O₃, used in the preparation of the catalyst of this invention 1, 7, 6, 13, 12, 11, 21 and 18, respectively. The catalytic activity of the above was carried out by the procedure same as that described in EXAMPLES 23-58 at reaction conditions given in tables 10-11. The results are included in tables 10-11.

The results in TABLES 10-11 indicate that the Si-MCM-41, silicalite, Mont.-K10, Al₂O₃)B₂O₃, CaO, La₂O₃ and Y₂O₃, used for the catalyst preparation in EXAMPLES 1, 7, 6, 13, 12, 11, 21 and 18, respectively, showed little or no activity in the benzylation of toluene by benzyl chloride. However, after their halogenation by the process of this invention, they are activated and show very high activity for the Friedel-Crafts reactions; as shown in Examples 27, 43, 42, 49, 48, 47, 57 and 54, respectively. These results clearly shows that the inorganic solids which have no catalytic activity for the Friedel-Crafts reaction can be activated by the process of this invention and after activation by halogenation by the process of this invention, the resulting partially halogenated catalysts show very high activity for the Friedel-Crafts reactions.

TABLE-10
Reaction conditions and results of the benzylation of Toluene over different solid
catalysts used for the preparation of the catalysts in EXAMPLES 1, 7, 6, 13, respectively.

| | Example Nos. | | | |
|---|---|---|---|---|
| | EXAMPLE-59 | EXAMPLE-60 | EXAMPLE-61 | EXAMPLE-62 |
| Catalyst used | Si-MCM-41 | Silicalite-I used | Mont-10 used | Al₂O₃ used in |
| | used in catalyst | in the catalyst | in the catalyst | the catalyst |
| | preparation in | preparation in | preparation in | preparation in |
| | EXAMPLE-1 | EXAMPLE-7 | EXAMPLE-6 | EXAMPLE-13 |
| Reactants: | | | | |
| Aromatic | C₆H₅CH₃ | C₆H₅CH₃ | C₆H₅CH₃ | C₆H₅CH₃ |
| Compound (Ac) | (Toluene) | (Toluene) | (Toluene) | (Toluene) |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | Nil | Nil | Nil |
| Ac/Ba mole ratio | 13.0 | 13.0 | 13.0 | 13.0 |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature (° C.) | 110° C. | 110° C. | 110° C. | 110° C. |
| Pressure (atm) | 1.0 | 1.0 | 1.0 | 1.0 |
| N₂ flow (cm³ min⁻¹) | 30.0 | 30.0 | 30.0 | 30.0 |
| Reaction time (h) | 2.0 | 2.0 | 2.0 | 2.0 |
| Conversion of | No Reaction for | No Reaction for | No Reaction | No Reaction for |
| benzylating | 2.0 h | 2.0 h | for 2.0 h | 2.0 h |
| agent (%) | | | | |

TABLE 11
Reaction conditions and results of the benzylation of Toluene over solid catalysts
used for the preparation of the catalysts in EXAMPLES 12, 11, 21, 18, respectively.

| | Example Nos. | | | |
|---|---|---|---|---|
| | EXAMPLE-63 | EXAMPLE-64 | EXAMPLE-65 | EXAMPLE-66 |
| Catalyst used | B₂O₃ used in the | CaO used in the | La₂O₃ used in the | Y₂O₃ used in the |
| | catalyst | catalyst | catalyst | catalyst preparation |
| | preparation in | preparation in | preparation in | in EXAMPLE-18 |
| | EXAMPLE-12 | EXAMPLE-11 | EXAMPLE-21 | |
| Reactants: | | | | |
| Aromatic | C₆H₅CH₃ | C₆H₅CH₃ | C₆H₅CH₃ | C₆H₅CH₃ |
| Compound (Ac) | (Toluene) | (Toluene) | (Toluene) | (Toluene) |
| Benzylating | C₆H₅CH₂Cl | C₆H₅CH₂Cl | C₆H₅CH₂Cl | C₆H₅CH₂Cl |
| agent (Ba) | | | | |
| Reaction | | | | |
| Conditions: | | | | |
| Solvent | Nil | Nil | Nil | Nil |
| Ac/Ba mole | 13.0 | 13.0 | 13.0 | 13.0 |
| ratio | | | | |
| Solvent/Ba mole | 0.0 | 0.0 | 0.0 | 0.0 |
| ratio | | | | |
| Catalyst/Ba | 0.1 | 0.1 | 0.1 | 0.1 |
| weight ratio | | | | |
| Temperature(° C.) | 110° C. | 110° C. | 110° C. | 110° C. |
| Pressure (atm) | 1.0 | 1.0 | 1.0 | 1.0 |
| N₂ flow | 30.0 | 30.0 | 30.0 | 30.0 |
| (cm³min⁻¹) | | | | |
| Reaction time | 2.0 | 2.0 | 2.0 | 2.0 |
| (h) | | | | |
| Conversion of | No Reaction for | No Reaction for | No Reaction for | No Reaction for 2.0 h |
| benzylating | 2.0 h | 2.0 h | 2.0 h | |
| agent (%) | | | | |

The Novel Features and Main Advantages of the Solid Catalyst of this Invention over the Prior Art Catalysts Useful for the Friedel-Crafts Reactions are as Follows:

1. The solid catalyst of this invention is, a partially halogenated inorganic solid, having very high activity in the Friedel-Crafts reaction. By the process of this invention, catalytically inactive inorganic solids can be activated by their halogenation, yielding highly active but inexpensive or very low cost catalyst useful for Friedel-Crafts reactions.

2. The solid catalyst of this invention has a number of advantages over the earlier homogeneous catalysts used for the Friedel-Crafts reactions, as follows:

According to this invention
i) the catalyst used for the Friedel-Crafts reaction is heterogeneous solid catalyst and hence it can be separated from the reaction products easily, simply by filtration.
ii) the separated catalysts can be reused in the process for a number of times, and
iii) also the catalysts are non corrosive, therefore most of the serious problems associated with homogeneous catalyst used in the earlier homogeneous catalysed Friedel-Crafts reactions are overcome by the solid catalyst of this invention.

3) The catalyst of this invention has also number of advantages over the prior art solid catalysts used for the Friedel-Crafts reactions, as follows:
i) The activity of the catalyst of this invention in the Friedel-Crafts reaction is higher and hence the time required to complete the reaction is much shorter.
ii) The catalyst of the present invention can be used for the Friedel-Crafts reactions involving reactants of any molecular size i.e. for both small and big reactant molecules.
iii) By using the catalysts of this invention, the Friedel-Crafts reactions can be carried out at mild reaction conditions even though when the aromatic compound does not contain any aromatic nucleus activating group or electron donating group, for example when the aromatic compound is benzene of naphthalene.

1. A solid catalyst consisting of partially halogenated metal oxide or mixed metal oxide or zeolite or zeolite-like solid, represented by a general formula X(a)/P_{b}MO_{c}(OH)_{d} wherein, X is halogen element selected from F, CL, Br and I; P is phosphorous element; M is at least one metallic element selected from alkaline earth metals, rare earth metals, group IIIa metals, non-noble transition metals, Sn, Sb, Bi, Si, thorium and uranium; O is oxygen; H is hydrogen; a is the concentration of halogen element X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support, useful for the Friedel-Crafts reactions.

2. A catalyst as claimed in claim 1 wherein the halogen element is Cl.

3. A catalyst as claimed in claim 1 wherein the metallic element (M) is Be, Mg, Ca, Si, B, Al, Ga, In, Tl, Cr, Fe, Cu, Ni, Y, Th, La, Ce, Pr, Bi or a mixture of two or more thereof.

4. A catalyst as claimed in claim 1 wherein the concentration of halogen element in the catalyst (a) is between 0.1 wt % and 30 wt %.

5. A process for the preparation of a solid catalyst, consisting of partially halogenated metal oxide or mixed metal oxide or zeolite or zeolite-like solid, represented by a general formula: X(a)/P_{b}MO_{c}(OH)_{d}
wherein X is halogen element selected from F, Cl, Br and I; P is phosphorous element; M is at least one metallic element selected from alkaline earth metals, rare earth metals, group IIIa metals, non-noble transition metals, Sn, Sb, Bi, Si, thorium and uranium; O is oxygen; H is hydrogen; a is the concentration of halogen element X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support, useful for the Friedal-Crafts reactions.
which comprises;
(i) contacting an inorganic solid comprising surface hydroxyl groups, represented by a general formula: P_{b}MOₙ(OH)ₘ
wherein, P is phosphorous, M is at least one metallic element selected from alkaline earth metals, rare earth metals, group IIIa metals, non-noble transition metals, Sn, Sb, Bi, Si, thorium and uranium; O is oxygen; H is hydrogen; b is the mole ratio of P to M in the range from zero to 1.0; n and m are the number of oxygen and OH groups, respectively, required to satisfy the valence requirement of the metallic and nonmetallic elements (M and P), and the m to n ratio is above about 0.0001, with or without any catalyst support, with an halogenating agent selected from hydrogen fluoride, hydrogen chloride, hydrogen bromide, hydrogen iodide or gaseous halogens in the presence or absence of moisture free non-aqueous solvent and inert gas, such that the concentration of halogen in the catalyst is in the range from 0.01 wt % to 50 wt %; and
(ii) desorbing physically adsorbed halogen containing compound from the halogenated solid.

6. A process as claimed in claim 5 wherein, the halogenating agent is anhydrous hydrogen chloride or Cl₂.

7. A process as claimed in claim 5 wherein, the metallic element [M] in the inorganic solid is Be, Mg, Ca, Si, B, Al, Ga, In, Tl, Cr, Fe, Cu, Ni, Y, Th, La, Ce, Pr, Bi or a mixture of two or more thereof.

8. A process as claimed in claim 5 wherein the non-aqueous solvent is liquid hydrocarbon, carbon tetrachloride or dichloroethane.

9. A process as claimed in claim 5 wherein the concentration of halogen in the catalyst is between 0.1 wt % and 30 wt %.

10. A process as claimed in claim 5 wherein in step ii the physically absorbed or adsorbed halogen or halogen containing compound from the halogenated inorganic solid is removed by desorption from the catalyst in a flow of inert gas such as nitrogen, helium or argon.

11. A process as claimed in claim 5 wherein when an non-aqueous solvent is used in step-i, after the desorption of physically adsorbed or absorbed halogenating agent, the resulting halogenated catalyst is filtered under moisture-free atmosphere and is dried under vacuum to remove the solvent from the catalyst.

12. A process for the benzylation of an aromatic compound comprising i) contacting a pretreated catalyst of claim 1 with 15 cm³ liquid reaction mixture containing aromatic compound and benzyl chloride or benzoyl chloride and optionally a solvent under vigorous stirring while bubbling moisture-free N₂ gas through the reaction mixture ii) cooling the reaction mixture to room temperature, separating the solid catalyst from therefrom by filtration to obtain a benzoylated aromatic compound.

13. A process as claimed in claim 12 wherein the separated catalyst is washed with moisture-free solvent selected from benzene and toluene and recycled.

14. A process as claimed in claim 12 wherein the catalyst is of the general formula X(a)/P_{b}MO_{c}(OH)_{d} wherein, X is halogen element selected from F, Cl, Br and I; P is phosphorous element; M is at least one metallic element selected from alkaline earth metals, rare earth metals, group IIIa metals, non-noble transition metals, Sn, Sb, Bi, Si, thorium and uranium; O is oxygen; H is hydrogen; a is the concentration of halogen element X present in the catalyst in the range from 0.01 wt % to 50 wt %; b is the mole ratio of P to M in the range from zero to 1.0; c and d are the number of oxygen and OH groups, respectively, required to satisfy the valence requirement of the metallic and nonmetallic elements (M and P); and the ratio of d to c in the range from zero to about 1.0, with or without any catalyst support.

15. A process as claimed in claim 14 wherein, the halogenating agent is anhydrous hydrogen chloride or Cl₂.

16. A process as claimed in claim 14 wherein, the metallic element [M] in the inorganic solid is Be, Mg, Ca, Si, B, Al, Ga, In, Tl, Cr, Fe, Cu, Ni, Y, Th, La, Ce, Pr, Bi or a mixture of two or more thereof.

17. A process as claimed in claim 14 wherein the non-aqueous solvent is liquid hydrocarbon, carbon tetrachloride or dichloroethane.

18. A process as claimed in claim 14 wherein the concentration of halogen in the catalyst is between 0.1 wt % and 30 wt %.
